(19) United States
(12) Patent Application Publication
(10) Pub. No.: US 2011/0199647 A1
(43) Pub. Date: Aug. 18, 2011

(54) WOVEN PATTERN IMAGE PROCESSING APPARATUS AND WOVEN PATTERN IMAGE PROCESSING METHOD

(75) Inventor: Yasuaki Okamoto, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/023,021

(22) Filed: Feb. 8, 2011

Related U.S. Application Data
(60) Provisional application No. 61/303,905, filed on Feb. 12, 2010.

(51) Int. Cl. G06F 15/00

(52) U.S. Cl. 358/1.16

(57) ABSTRACT

According to one embodiment, a woven pattern image processing apparatus includes: a woven-pattern-image-generation-area designating unit configured to arbitrarily designate one or plural woven pattern image generation areas in one page of a print sheet; a woven pattern image pattern memory configured to store at least a sign string appearing pattern and a copy prohibition pattern as woven pattern image patterns; a woven-pattern-image selecting unit configured to select the woven pattern image patterns to be stored in the woven pattern image pattern memory and selectively set the selected woven pattern image patterns in the woven pattern image generation areas; and an image control unit configured to combine, in the areas designated by the woven-pattern-image-generation-area designating unit, the woven pattern image patterns selected by the woven-pattern-image selecting unit with printing data of a document image to be printed in the one page of the print sheet.

### CROSS-REFERENCE TO RELATED APPLICATION

This application is based upon and claims the benefit of priority from: U.S. provisional application 61/303,905, filed on Feb. 12, 2010; the entire contents of each of which are incorporated herein by reference.

### FIELD

Embodiments described herein relate generally to a technique for woven pattern image embedding processing in an image processing apparatus including a woven pattern printing function.

### BACKGROUND

There is proposed an image processing apparatus including a woven pattern printing function for printing, when an original is obtained by printing document data of characters, photographs, or the like and woven pattern image data on one page of a print sheet with a printer and is read by a scanner and printed out, the original for the purpose of visualizing a woven pattern image such as “COPY” and printing the woven pattern image together with the document data to suppress a copying act.

In the woven pattern image, a latent image and a background are respectively formed by dots in, for example, a rectangular area of a predetermined size. The latent image cannot be recognized before copying but, when copied, remains after the copying. The background disappears or has low density compared with the visualized latent image after the copying to make it difficult to recognize the image.

As a pattern for embedding the woven pattern image, there are, for example, a pattern for embedding, at low density, a character string such as “copy prohibited” in a part of the one page of the original (a character string appearing pattern), a pattern for embedding, at high density, a character string over the entire one page of the original (a copy prohibition pattern), and a pattern for embedding, in a part of the one page of the original, identification information of a personal computer that outputs the document data to the printer and information such as output date and time (information tracking).

When the original is copied, if the visualized latent image overlaps a part of a document image, the character string appearing pattern makes the document image in the overlapping part unreadable. However, even if only a part of the document image has to be made unreadable, the visualized latent image cannot be superimposed on a place desired to be made unreadable.

When the original embedded with the woven pattern image by the copy prohibition pattern is copied, since the visualized latent image is copied to be superimposed on most of the document image, the document image is made unreadable. However, if confidentiality of the document image is low and the document image does not have to be completely prohibited from being copied, it is desired to make the document image readable even if the visualized latent image is printed.

### BRIEF DESCRIPTION OF THE DRAWINGS

FIG. 1 is an overall diagram of a woven pattern image processing apparatus according to an embodiment;

FIG. 2 is an image processing block diagram of the woven pattern image processing apparatus shown in FIG. 1;

FIG. 3 is a diagram for explaining a woven pattern image;

FIG. 4A is a diagram of a selection screen for a woven pattern in a display screen section of a control panel shown in FIG. 2, FIG. 4B is a diagram of a selection screen for a character string mode in the display screen section of the control panel shown in FIG. 2, and FIG. 4C is a diagram of a selection screen for a area designation mode in the display screen section of the control panel shown in FIG. 2;

FIG. 5 is a diagram of a woven-pattern-image-embedded-area designation screen in the display screen section of the control panel shown in FIG. 2;

FIG. 6 is a flowchart for explaining the operation of the woven pattern image processing apparatus shown in FIG. 2; and

FIG. 7 is a diagram of a copy image obtained by copying a printed-out original while designating only a part of a woven pattern embedded area with the woven pattern image processing apparatus shown in FIG. 2.

### DETAILED DESCRIPTION

In general, according to one embodiment, a woven pattern image processing apparatus includes: a woven-pattern-image-generation-area designating unit configured to arbitrarily designate one or plural woven pattern image generation areas in one page of a print sheet; a woven pattern image pattern memory configured to store at least a sign string appearing pattern and a copy prohibition pattern as woven pattern image patterns; a woven-pattern-image selecting unit configured to select the woven pattern image patterns to be stored in the woven pattern image pattern memory and selectively set the selected woven pattern image patterns in the woven pattern image generation areas; and an image control unit configured to combine, in the areas designated by the woven-pattern-image-generation-area designating unit, the woven pattern image patterns selected by the woven-pattern-image selecting unit with printing data of a document image to be printed in the one page of the print sheet.

In general, according to another embodiment, a woven pattern image processing method is a woven pattern image processing method for combining, in one page of a print sheet, a woven pattern image with printing data to be printed on the print sheet and printing the woven pattern image, the method including: designating one or plural woven pattern image generation areas for generating a woven pattern image in an arbitrary area in one page of a print sheet to be displayed on a screen; and selecting, from a woven pattern image pattern memory configured to store at least woven pattern image patterns including a sign string appearing pattern and a copy prohibition pattern, woven pattern image patterns to be generated in the designated woven pattern image generation areas.

A woven pattern image processing apparatus according to an embodiment is explained in detail below with reference to the accompanying drawings.

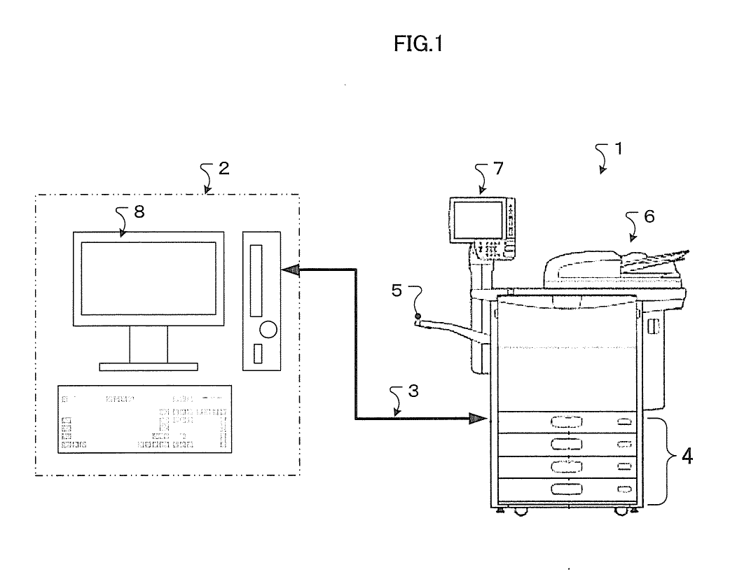

FIG. 1 is a diagram of an overall configuration of the woven pattern image processing apparatus according to the embodiment. A complex machine (a MFP (Multi Function Peripheral)) 1 as an example of an image forming apparatus including a printer function and a copy function and an information processing terminal 2 such as a personal computer are connected via, for example, a network 3. The MFP 1 feeds a sheet for printing in a paper feeding cassette 4 to be timed to coincide with printing by a printer unit (not shown), transfers, for example, a toner image of a color toner onto the sheet, fixes, with a fixing unit (not shown), the toner image on the sheet having the toner image transferred thereon, and discharges the sheet to a paper discharge tray 5. Printing data to be printed on the sheet is transmitted from the information processing terminal 2 to the MFP 1. The MFP 1 reads, with a scanner unit (not shown), for example, original documents stacked on an auto document feeder 6 one by one, transfers, with the printer unit, a read document image onto a sheet as a toner image, fixes, with the fixing unit (not shown), the toner image on the sheet having the toner image transferred thereon, and discharges the sheet to the paper discharge tray 5.

In this embodiment, the MFP 1 includes a woven-pattern-image processing unit configured to embed a woven pattern image in one page of a sheet. The MFP 1 combines the woven pattern image with the printing data transmitted from the information processing terminal 2 to the MFP 1. An operator is allowed to set a woven pattern image embedding area in an arbitrary area in the one page of the sheet while looking at a screen of a control panel 7. The operator may be allowed to arbitrarily set the woven pattern image embedding area in the information processing terminal 2 while looking at a monitor 8.

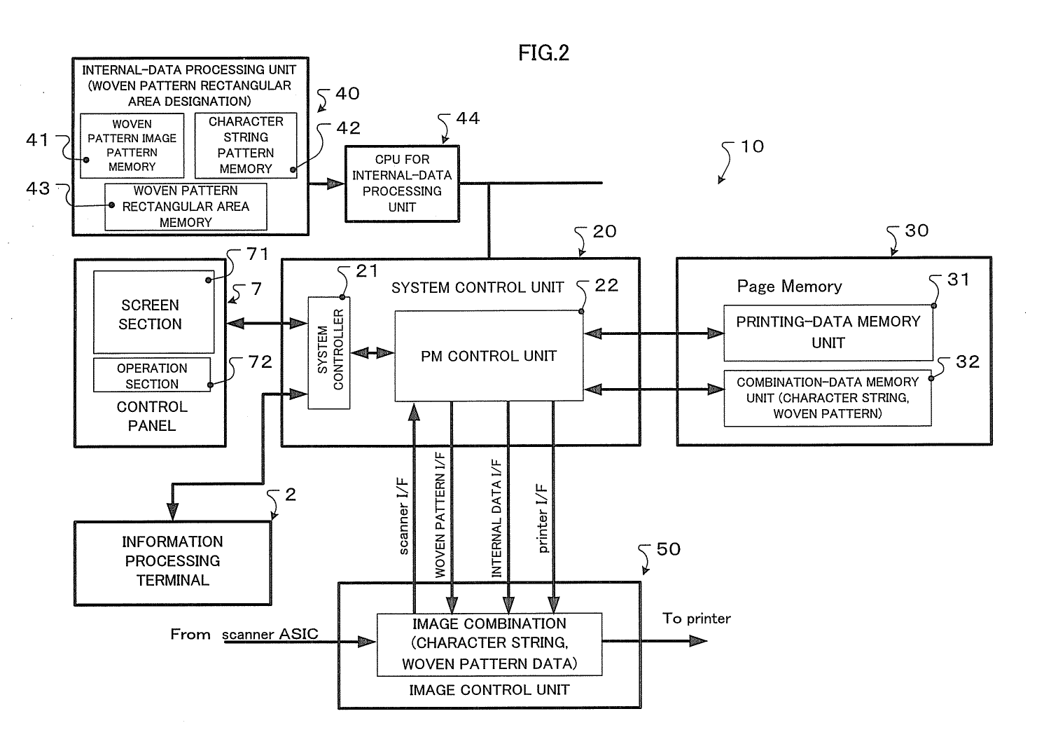

The configuration of the image processing unit is explained below with reference to FIG. 2.

An image processing unit 10 includes a system control unit 20 to which document data from the information processing terminal 2 is input via a system controller 21 and a page memory 30 configured to store, for each page of a print sheet, the document data input to the system control unit 20 in a printing-data memory unit 31.

The image processing unit 10 further includes an internal-data processing unit 40 including a woven pattern image pattern memory 41 configured to store patterns of a woven pattern image, a character string pattern memory 42 configured to store character string patterns, and a woven pattern rectangular area memory 43 configured to store woven pattern image embedding areas as rectangular areas. The internal-data processing unit 40 arbitrarily selects a woven pattern image pattern stored in the woven pattern image pattern memory 41 and a character string pattern stored in the character string pattern memory 42, which are displayed on a screen section 71 of the control panel 7, and causes a combination-data memory unit 32 of the page memory 30 to store the selected patterns. The internal-data processing unit 40 stores a woven pattern image embedding area designated on the screen section 71 of the control panel 7 in the woven pattern rectangular area memory 43 and causes the combination-data memory unit 32 to store the stored woven pattern image embedding area.

The image processing unit 10 includes an image control unit 50 configured to combine, for printing on a sheet, printing data and woven pattern image data stored in the printing-data memory unit 31 and the combination-data memory unit 32 of the page memory 30. Reference numeral 44 denotes a CPU for the internal-data processing unit 40.

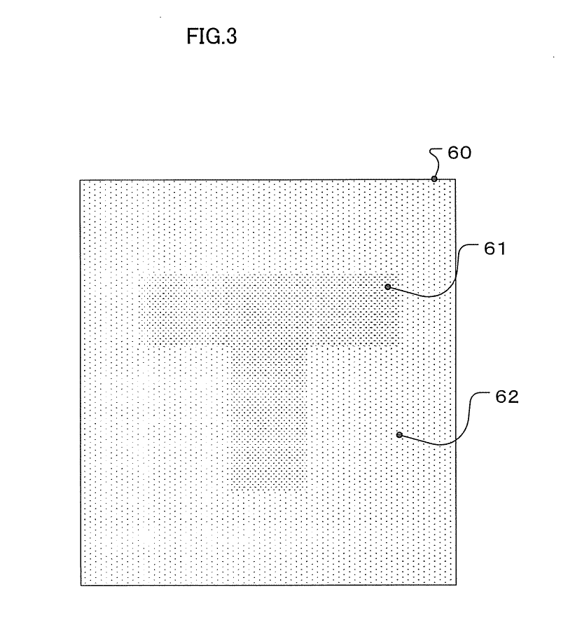

The woven pattern image pattern memory 41 of the internal-data processing unit 40 has stored therein, as patterns of a woven pattern image, a character string (sign string) appearing pattern, a copy prohibition pattern, and an information tracking pattern. Since the principle of a woven pattern image is publicly known, the principle is briefly explained. As shown in FIG. 3, an original is obtained by combining, for example, in a rectangular area 60 of a predetermined size for one character, a latent image 61 of, for example, a character “T” formed by large-diameter dots and a background 62 formed by small-diameter dots and forming the combined latent image 61 and background 62 on a sheet as a toner image. The small-diameter dots forming the latent image on the original are formed in a size that cannot be recognized by a scanner unit of a copying machine or a size that cannot be sufficiently recognized by the scanner unit. The large-diameter dots forming the latent image are formed in a size that can be sufficiently recognized by the scanner unit of the copying machine. A woven pattern image formed on the original makes it difficult to recognize the latent image 61 embedded in the background 62. When the original is copied, the latent image cannot be recognized before the copying but is recognized and remains as an image after the copying. After the copying, an image of the background disappears or has low density compared with the density of the visualized latent image to make it difficult to recognize the background. The latent image is visualized to appear. In other words, in the sign string appearing pattern and the copy prohibition pattern, a form of visualization in a copying state is different.

The character string appearing pattern is a pattern for embedding characters, numbers, or signs such as marks in, for example, a rectangular area in which characters are formed. The character string is not limited to a character string set in advance and can be arbitrarily set by, for example, the information terminal 2.

In the copy prohibition pattern, for example, the large-diameter dots and the small-diameter dots are alternately formed in a matrix shape in a rectangular area.

The information tracking pattern is a pattern for printing, for example, date and time of creation of an original, identification information of the information terminal 2 that transmits document data, and a name of an owner of the information terminal 2. The information tracking pattern is formed at an end of a sheet not to overlap printing data. A background of woven pattern data may be formed and information tracking data may be printed during copying of an original. When the information tracking data is printed on the original, the background may be omitted and the information tracking data may be recognized on the original. The background and the information tracking data may be able to be selected.

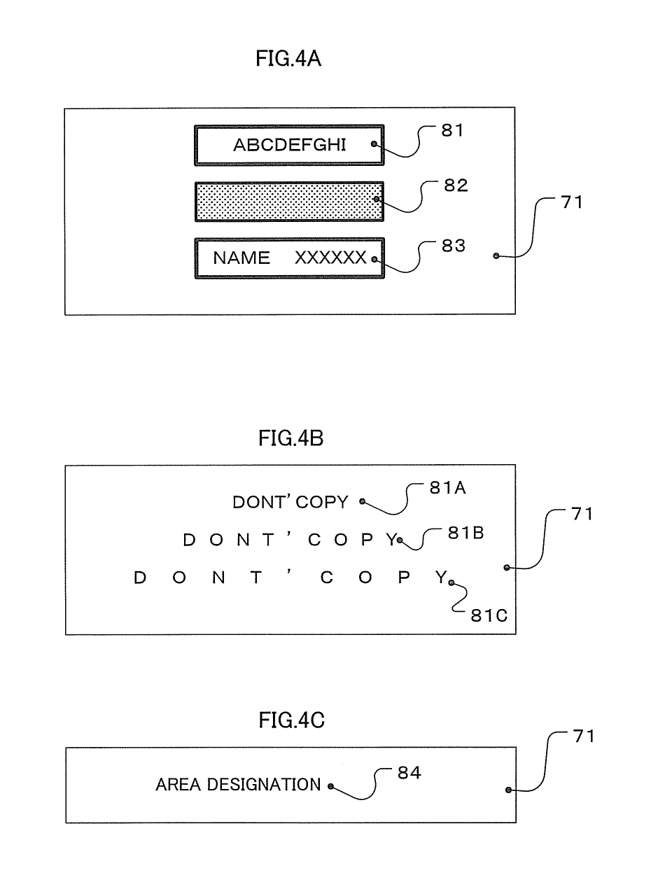

When printing of a woven pattern image is selected, as shown in FIG. 4A, indicators of the three kinds of woven pattern image patterns, i.e., an indicator 81 of the character string appearing pattern, an indicator 82 of the copy prohibition pattern, and an indicator 83 of the information tracking pattern are displayed on the screen section 71 of the control panel 7. The operator touches an operation key of an operation section 72 or a touch panel of the control panel 7 to select any one of the patterns.

In this embodiment, in the character string pattern memory 42 of the internal-data processing unit 40, plural patterns having different character intervals are stored as the character string appearing pattern. As shown in FIG. 4B, a first character string pattern 81A having a standard character interval, a second character string pattern 81B having a character interval larger than that of the first character string pattern 81A, and a third character string pattern 81C having a character interval larger than that of the second character string pattern 81B are displayed. The operator touches the operation key of the operation section 72 or the touch panel of the control panel 7 to select any one of the character string patterns. Intervals of character strings are not limited to these three kinds. Patterns having further expanded intervals may be prepared. The operator may be allowed to arbitrarily set intervals of character strings.

In this embodiment, the patterns of the woven pattern image have an area designation mode for allowing the operator to form the woven pattern image in an arbitrary position of one page of a sheet. As shown in FIG. 4C, when an indicator 84 for area designation is displayed on the screen section 71 of the control panel 7, the operator touches the operation key of the operation section 72 or the touch panel of the screen section 71 of the control panel 7 to select area designation.

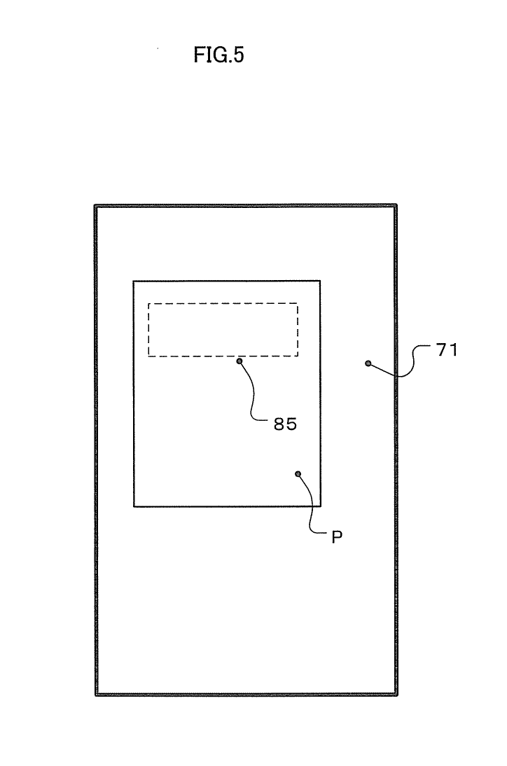

In the area designation, as shown in FIG. 5, the operator designates a woven pattern rectangular area section 85 in arbitrary size in an arbitrary position on one page of a sheet P displayed on the screen section 71 of the control panel 7. As a method of designating the woven pattern rectangular area section 85, the operator touches the operation key of the operation section 72 or the touch panel of the screen section 71 of the control panel 7 to designate the woven pattern rectangular area section 85.

In the area designation, the woven pattern rectangular area section 85 can be designated in one place or plural places. A pattern of the woven pattern image to be formed in a plurality of the designated woven pattern rectangular area sections 85 is not limited to one of the character string appearing pattern, the copy prohibition pattern, and the information tracking pattern. These patterns can be arbitrarily selected.

The selection of the pattern of the woven pattern image to be combined with the printing data to be printed on the one page of the sheet and the character sting pattern of the woven pattern image and the area designation for the woven pattern image are determined in this way. Then, the internal-data processing unit 40 stores, as data of one page of a print sheet, internal data as woven pattern image area designation data in the combination-data memory unit 32 of the page memory 30 as combination data together with the pattern of the woven pattern image and the character string pattern of the woven pattern image formed in the woven pattern rectangular area sections 85.

The printing data stored in the printing-data memory unit 31 of the page memory 30 and the combination data stored in the combination-data memory unit 32 are controlled by a page-memory (PM) control unit 33 of the system control unit 20 and transmitted to the image control unit 50.

The image control unit 50 receives the printing data from the PM control unit 20 via a printer I/F, receives the internal data as the woven pattern image area designation data via an internal data I/F, and receives the pattern of the woven pattern image and the character string pattern of the woven pattern image via a woven pattern I/F. The image control unit 50 transmits these received data to the printer unit and forms, in a designated area of a sheet, an image obtained by combining the selected pattern of the woven pattern image with the printing data in the selected character string pattern.

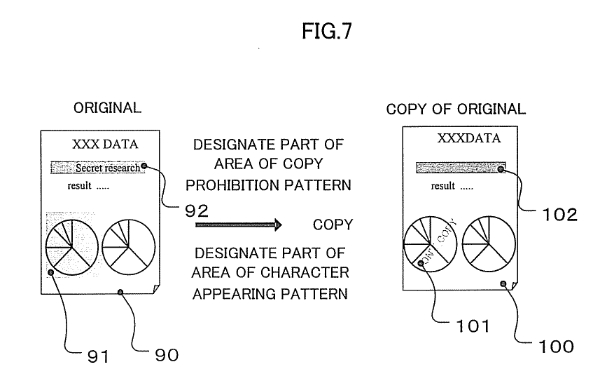

FIG. 7 is a diagram of an example in which, in an original 90, the woven pattern rectangular area sections 85 are designated concerning an area 91 of printing data of a pie chart and an area 92 of printing data of characters and the character string appearing pattern is selected for the area 91 and the copy prohibition pattern is selected for the area 92. When the original 90 is copied, in an area 101 of the printing data of the pie chart corresponding to the area 91, “DON'T COPY” is obliquely printed but the printing data of the pie chart can be recognized. On the other hand, an entire area 102 of the printing data of the characters corresponding to the area 92 is filled with densely printed dots and the printing data of the characters cannot be read.

If the printing data of the pie chart in the area 91 has low confidentiality and the printing data of the characters in the area 92 has high confidentiality in the printing data printed on the original 90, when the original 90 is copied, in the printing data printed on a copied sheet, reading of the data having high confidentiality is disabled and reading of the data having low confidentiality is enabled. If the characters of the character appearing pattern interfere with the printing data and it is difficult to read the printing data, reading of the printing data is enabled by selecting a character string pattern having a wide character interval.

In a copy mode, the image control unit 50 stores an image signal read by the scanner unit in the printing-data memory unit 31 of the page memory 30 via a scanner I/F, outputs printing data to the printer unit via the printer I/F, and prints an image for each page.

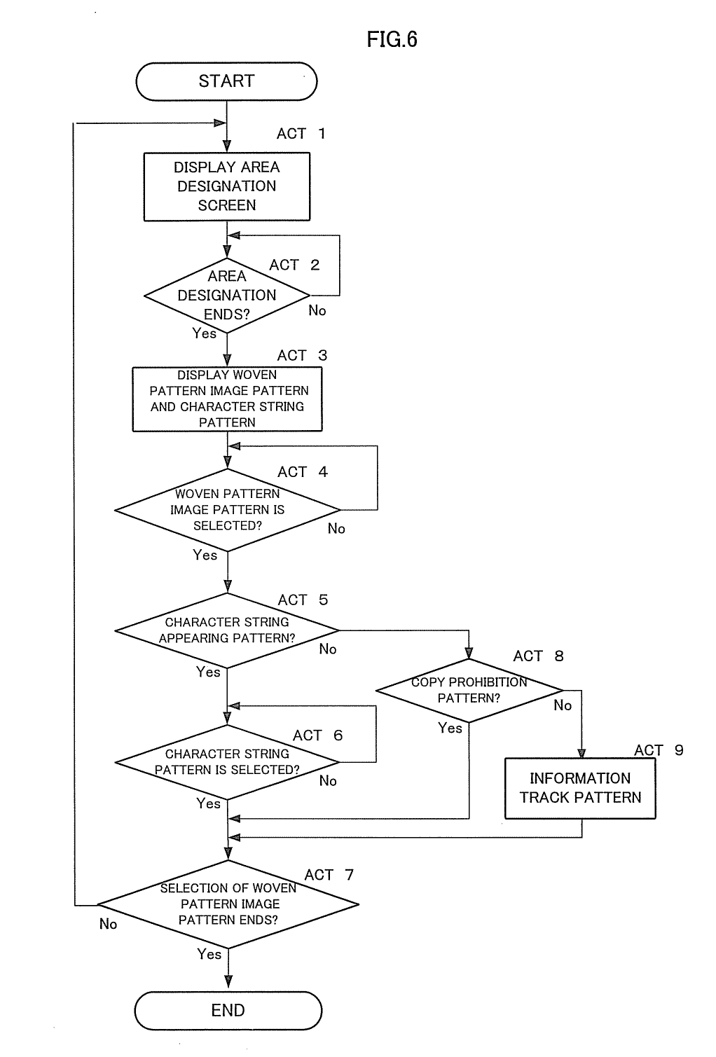

An example of the operation of the internal-data processing unit 40 shown in FIG. 2 is explained below with reference to a flowchart of FIG. 6.

In ACT 1, the internal-data processing unit 40 displays an area designation screen shown in FIG. 5 on the screen section 71 of the control panel 7 and proceeds to ACT 2.

If designation of an generation area in which a woven pattern image is embedded ends in ACT 2, the internal-data processing unit 40 proceeds to ACT 3.

In ACT 3, the internal-data processing unit 40 displays the woven pattern image patterns including the character string appearing pattern, the copy prohibition pattern, and the information track pattern shown in FIG. 4A and the character string pattern shown in FIG. 49 on the screen section 71 of the control panel 7 and proceeds to ACT 4.

In ACT 4, the internal-data processing unit 40 selects any one of the woven image patterns displayed in ACT 3 and proceeds to ACT 5.

In ACT 5, if the selected pattern is the character string appearing pattern, the internal-data processing unit 40 proceeds to ACT 6.

In ACT 6, the internal-data processing unit 40 selects the character string pattern shown in FIG. 4B displayed on the screen section 71 and proceeds to ACT 7. The internal-data processing unit 40 stores, in the woven pattern rectangular area memory 43, generation of the woven pattern image pattern of the character string pattern selected in ACT 6 in the area designated in ACT 2.

In ACT 7, the internal-data processing unit 40 determines whether the selection of the woven pattern image pattern is ended. If the internal-data processing unit 40 determines that the selection of the woven pattern image pattern is ended, the internal-data processing unit 40 ends the operation. If the selection of the woven pattern image pattern is continued, the internal-data processing unit 40 returns to ACT 1.

If the woven pattern image pattern other than the character appearing pattern is selected in ACTS 4 and 5, in ACT 8, the internal-data processing unit 40 determines whether the woven pattern image pattern is the copy prohibition pattern.

If the internal-data processing unit 40 determines in ACT 8 that the copy prohibition pattern is selected, the internal-data processing unit 40 stores, in the woven pattern rectangular area memory 43, generation of the woven pattern image pattern of the copy prohibition pattern in the area designated in ACT 2 and proceeds to ACT 7. If the copy prohibition pattern is not selected, the internal-data processing unit 40 proceeds to ACT 9.

In ACT 9, the internal-data processing unit 40 sets the information tracking pattern, stores, in the woven pattern rectangular area memory 43, generation of the woven pattern image pattern of the set information tracking pattern in the area designated in ACT 2, and proceeds to ACT 7.

In the operation of the internal-data processing unit 40, the internal-data processing unit 40 performs the selection of the woven pattern image pattern and the area designation using the control panel 7 of the MFP 1. However, the internal-data processing unit 40 may perform the selection of the woven pattern image pattern and the area designation using the information processing terminal 2.

In the example of the processing explained with reference to FIG. 6, the internal-data processing unit 40 causes the CPU for internal data processing 44 to execute a computer program stored in advance in a storage area provided in the MFP 1. However, the computer program may be downloaded from a network to the MFP 1. The computer program stored in a computer-readable recording medium may be installed in the MFP 1. The recording medium only has to be a recording medium that can store the computer program and can be read by a computer. As the recording medium, for example, a RAM (Random Access Memory), a ROM (Read Only Memory), a DRAM, an SRAM (Static Random Access Memory), a VRAM (Video RAM), or a flash memory can be used.

The present invention can be carried out in various other forms without departing from the spirit or the main characteristics thereof. Therefore, the embodiments are merely examples in every aspect and should not be limitedly interpreted. The scope of the present invention is indicated by the scope of claims and is by no means restricted by the text of the specification. Further, all modification and various improvements, substitutions, and alterations belonging to the scope of equivalents of the scope of claims are within the scope of the present invention.

What is claimed is:

1. A woven pattern image processing apparatus comprising:
a woven-pattern-image-generation-area designating unit configured to arbitrarily designate one or plural woven pattern image generation areas in one page of a print sheet;
a woven pattern image pattern memory configured to store at least a sign string appearing pattern and a copy prohibition pattern as woven pattern image patterns;
a woven-pattern-image selecting unit configured to select the woven pattern image patterns to be stored in the woven pattern image pattern memory and selectively set the woven pattern image patterns in the woven pattern image generation areas; and
an image control unit configured to combine, in the areas designated by the woven-pattern-image-generation-area designating unit, the woven pattern image patterns selected by the woven-pattern-image selecting unit with printing data of a document image to be printed in the one page of the print sheet.

2. The apparatus according to claim 1, further comprising a sign string pattern memory including, with respect to the sign string appearing pattern, plural sign string patterns having different intervals of signs that form a sign string, wherein
the apparatus selects, with the woven-pattern-image selecting unit, any one of the sign string patterns stored in the sign string pattern memory.

3. The apparatus according to claim 1, further comprising a printer unit configured to print an image on a print sheet, wherein
the apparatus prints an image combined by the image control unit on the print sheet.

4. The apparatus according to claim 1, wherein the apparatus sets, with the woven-pattern-image selecting unit, a same woven pattern image pattern or different woven pattern image patterns in the plural woven pattern image generation areas designated by the woven-pattern-image-generation-area designating unit.

5. The apparatus according to claim 1, further comprising an information processing terminal configured to transmit data of a document image, wherein
the woven-pattern-image selecting unit is provided in the information processing terminal.

6. A woven pattern image processing method for combining, in one page of a print sheet, a woven pattern image with printing data to be printed on the print sheet and printing the woven pattern image, the method comprising:
designating one or plural woven pattern image generation areas for generating a woven pattern image in an arbitrary area in one page of a print sheet to be displayed on a screen; and
selecting, from a woven pattern image pattern memory configured to store at least woven pattern image patterns including a sign string appearing pattern and a copy prohibition pattern, woven pattern image patterns to be generated in the designated woven pattern image generation areas.

7. The method according to claim 6, further comprising arbitrarily selecting the sign string appearing pattern out of plural sign string patterns having different intervals of signs.

8. The method according to claim 6, further comprising printing, in a printer unit, image combined data obtained by combining woven pattern image data with the printing data.

9. The method according to claim 6, further comprising setting a same woven pattern image pattern or different woven pattern image patterns with respect to the designated plural woven pattern image generation areas.

10. The method according to claim 6, further comprising performing, with an information processing terminal configured to transmit data of a document image, the designation of the woven pattern image generation areas and the selection of the woven pattern image patterns.
